(19) United States
(12) Patent Application Publication
(10) Pub. No.: US 2023/0258218 A1
(43) Pub. Date: Aug. 17, 2023

(54) METHOD AND APPARATUS FOR A FASTENER HAVING A PROGRESSIVE THREAD PROFILE

(71) Applicant: Fontana Fasteners R.D. s.r.l, Veduggio con Calzano (IT)

(72) Inventors: Gabriele Carli Moretti, Como (IT); David Curtis Goss, Rockford, IL (US); Paolo Redaelli, Monastero (IT); Francesco Perego, Merate (IT); Sergio Cattaneo, Magenta (IT)

(73) Assignee: Fontana Fasteners R.D. s.r.l, Veduggio con Calzano (IT)

(21) Appl. No.: 18/153,316

(22) Filed: Jan. 11, 2023

Related U.S. Application Data
(60) Provisional application No. 63/303,020, filed on Jan. 25, 2022.

(51) Int. Cl. F16B 25/00

(52) U.S. Cl. CPC F16B 25/0047

(57) ABSTRACT

A novel threaded fastener is provided having an elongated shank portion with a first end and a second end opposed to the first end, and a helical thread in the form of a continuous helical ridge that is arranged on an external surface of the shank portion. The helical thread includes an asymmetrical threaded portion that has a progressively increasing axial displacement of a pressure flank of the helical thread between the first end and the second end of the shank portion, and a progressively decreasing axial displacement of a non-pressure flank of the helical thread between the first end and the second end of the shank portion. When assembled, the novel threaded fastener has a clamping force distribution that is evenly distributed on the helical threads along its axis in the direction of force transmission reducing the risk of self-loosening and increasing fatigue resistance.

### CROSS-REFERENCE TO RELATED APPLICATIONS

This application claims the benefit of U.S. Provisional Patent Application No. 63/303,020 filed on Jan. 25, 2022, the disclosure of which is hereby incorporated by reference.

### INTRODUCTION

A threaded fastener is employable to exert a clamping force on an assembled product. A threaded fastener assembly includes a threaded fastener that meshingly engages a threaded receiver, e.g., a threaded nut, to exert a clamping force. The clamping force being exerted by a fastener assembly may decrease in-use due to a loosening of the threaded bolt and nut, wherein the loosening of the threaded bolt and nut may be due to fluctuations in ambient temperature, vibration, load variations, fatigue, impact stress and other factors capable of varying when the fastener assembly is deployed.

There is a need for a fastener and fastener assembly that maintains its clamping force in-use, and is thus able to resist loosening, and resist fatigue when deployed. There is a need for a fastener and fastener assembly that provides an improved clamp load retention of an assembled joint in use.

### SUMMARY

The concepts described herein provide a threaded fastener and/or a fastener assembly that maintain clamping force in-use, and are thus able to resist loosening, resist fatigue, and provide an improved clamp load retention of an assembled joint in use. A novel threaded fastener is provided having an elongated shank portion with a first end and a second end opposed to the first end, and a helical thread in the form of a continuous helical ridge that is arranged on an external surface of the shank portion. The helical thread includes threaded portion with a progressively changing thread profile having a progressively increasing axial displacement of a pressure flank of the helical thread between the first end and the second end of the shank portion, and a progressively decreasing axial displacement of a non-pressure flank of the helical thread between the first end and the second end of the shank portion. When assembled, the novel threaded fastener has a clamping force distribution that is evenly distributed on the helical threads along its axis in the direction of force transmission.

An aspect of the disclosure may include the progressively increasing axial displacement of the pressure flank of the helical thread being disposed between a first engaged thread portion that is proximal to the first end of the shank portion and a final engaged thread portion that is proximal to the second end of the shank portion, and a progressively decreasing axial displacement of a non-pressure flank of the helical thread between the first engaged thread portion and the final engaged thread portion of the asymmetrical threaded portion of the helical thread.

Another aspect of the disclosure may include the progressively increasing axial displacement of the pressure flank of the helical thread being determined for a plurality of successive helical elements employing a progressive relief relationship to achieve a uniform load distribution along the pressure flank of the helical thread between the first engaged helical thread portion and the final engaged helical thread portion.

Another aspect of the disclosure may include a head portion arranged on the second end of the shank portion, wherein the head portion is engageable by a tool.

Another aspect of the disclosure may include a longitudinal cross-sectional area of the helical thread being constant throughout the asymmetrical threaded portion.

Another aspect of the disclosure may include the progressively increasing axial displacement of the pressure flank of the helical thread being determined for the plurality of successive helical elements employing a progressive relief relationship to achieve a uniform load distribution along the pressure flank of the helical thread between the first engaged thread portion and the final engaged thread portion of the helical thread.

Another aspect of the disclosure may include the progressive relief relationship to achieve the uniform load distribution along the threads includes each successive arc length of the helical thread being determined based upon a progression relationship, wherein the progression relationship is defined as a function sfi=f(i,n,sf), wherein i represents an i-th engaged helical thread portion, n represents total quantity of engaged thread portions, sfi represents an axial displacement from a nominal symmetrical helical thread for the i-th helical engaged thread portion; and sf represents a total axial displacement based upon an expected deflection of the helical thread between a first engaged helical thread portion and a final engaged helical thread portion in-use.

Another aspect of the disclosure may include the progression relationship of the progressive relief relationship being a linear relationship, or alternatively, another progression relationship.

Another aspect of the disclosure may include the non-pressure flank being determined to maintain a uniform longitudinal cross-sectional area of the helical thread between the first engaged thread portion and the final engaged thread portion of the helical thread. In some cases, a minor diameter of the first and second can be adapted to achieve a constant longitudinal cross-section, i.e., have a constant thread volume.

Another aspect of the disclosure may include the asymmetrical threaded portion being composed of a plurality of successive helical elements arranged in series, wherein the progressively increasing axial displacement is determined for the plurality of successive helical elements based upon an expected deflection of a respective one of the plurality of successive helical elements when in-use.

Another aspect of the disclosure may include the progressively increasing axial displacement being determined for each of the plurality of successive helical elements to achieve a load that is evenly distributed on the plurality of successive helical elements of the helical thread in-use.

Another aspect of the disclosure may include the threaded fastener being formed from a blank shank having a head portion and the shank portion, wherein the shank portion comprises a cylindrical-shaped shank portion, wherein the cylindrical-shaped shank portion has a constant diameter due to the constant thread volume, and wherein the helical thread is cold-rolled onto the external surface of the cylindrical-shaped shank portion.

Another aspect of the disclosure may include a fastener assembly that include a first element engageable to a second element via a threaded junction. The first element has a first helical thread portion, and the second element has a second helical thread portion that meshingly engages the first helical thread portion of the first element. The first helical thread portion has an asymmetrical helical thread including a progressively increasing axial displacement of a pressure flank of the first helical thread portion between a first end and a second end for the first element, and the asymmetrical threaded portion includes a progressively decreasing axial displacement of a non-pressure flank of the first helical thread portion between the first end and the second end of the first element.

Another aspect of the disclosure may include the first element being an elongated cylindrical shaft, and the asymmetrical portion of first helical thread being an external thread.

Another aspect of the disclosure may include the first element being a threaded nut, and the asymmetrical threaded portion of first helical thread being an internal thread.

Another aspect of the disclosure may include process for fabricating a threaded fastener that includes determining an arrangement for a continuous helical ridge, the arrangement for the continuous helical ridge including a plurality of helical elements having a progressively increasing axial displacement between a first end and a second end, wherein the progressive relief relationship achieves a uniform load distribution along a pressure flank of the continuous helical ridge between the first end and the second end. The process includes forming, via a cold-rolling process, the arrangement for the continuous helical ridge on an outer surface of a blank shank.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a side view of an embodiment of a fastener that includes a head portion and a shank portion, in accordance with the disclosure.

FIG. 2 schematically illustrates a cutaway side view of an asymmetrical threaded portion of a shank portion of a fastener, in accordance with the disclosure.

FIG. 3 schematically illustrates a process for designing and arranging asymmetrical helical threads of an asymmetrical threaded portion of a fastener in accordance with the disclosure.

FIG. 4 graphically illustrates a thread-specific load distribution for fasteners, in accordance with the disclosure.

FIG. 5 schematically illustrates a fastener assembly including an embodiment of a fastener having a threaded portion with asymmetrical helical threads in an unclamped state in accordance with the disclosure.

FIG. 6 schematically illustrates a fastener assembly including an embodiment of a fastener having a threaded portion with asymmetrical helical threads in a clamped state in accordance with the disclosure.

FIG. 7 schematically illustrates a meshed gearset having a worm gear with an asymmetrical threaded portion, in accordance with the disclosure.

FIGS. 8A and 8B schematically show a side-view (FIG. 8A) and corresponding end-view (FIG. 8B) of a shank of a multilobular fastener that has a continuous helical thread with an asymmetrical threaded portion in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein. Furthermore, the use of ordinals such as first, second and third does not necessarily imply a ranked sense of order, but rather may only distinguish between multiple instances of an act or structure. Like numerals refer to like elements throughout the drawings.

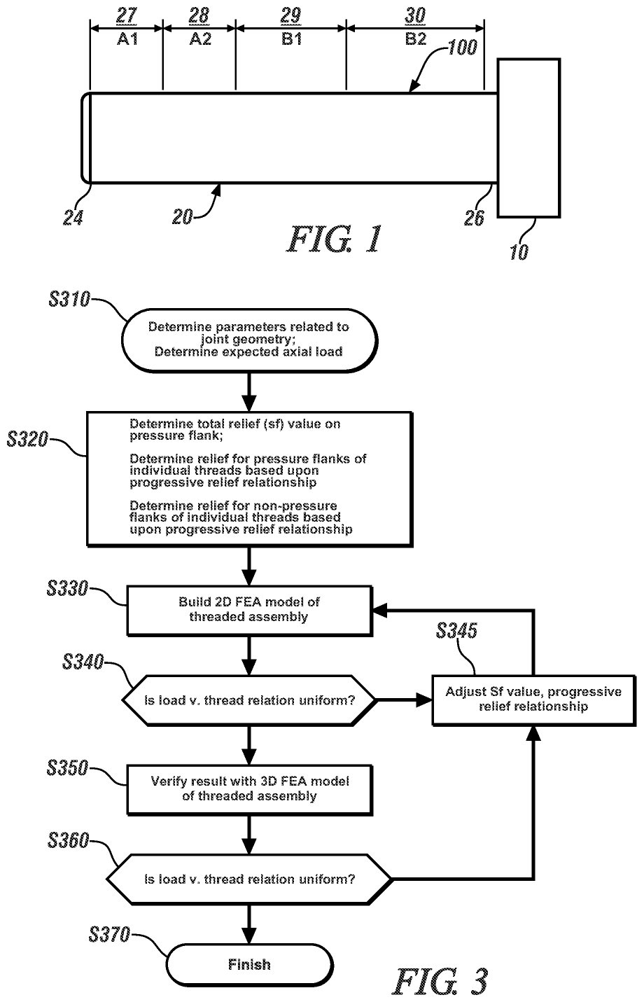

Referring now to the drawings, which are provided for the purpose of illustrating certain embodiments only and not for the purpose of limiting the same, FIG. 1 schematically illustrates a side view of an embodiment of a fastener 100 that includes a head portion 10 and a shank portion 20. The shank portion 20 is configured as an elongated cylinder with a first end 24 and a second end 26, with the head portion 10 being arranged on the second end 26 of the shank portion 20. The head portion 10 is configured to be engageable by a tool, and may be arranged with a hex configuration, a square configuration, a semi-spherical configuration having a slot, an internal cross-cut, an internal multilobular (e.g., hexalobular) arrangement, or another configuration without limitation.

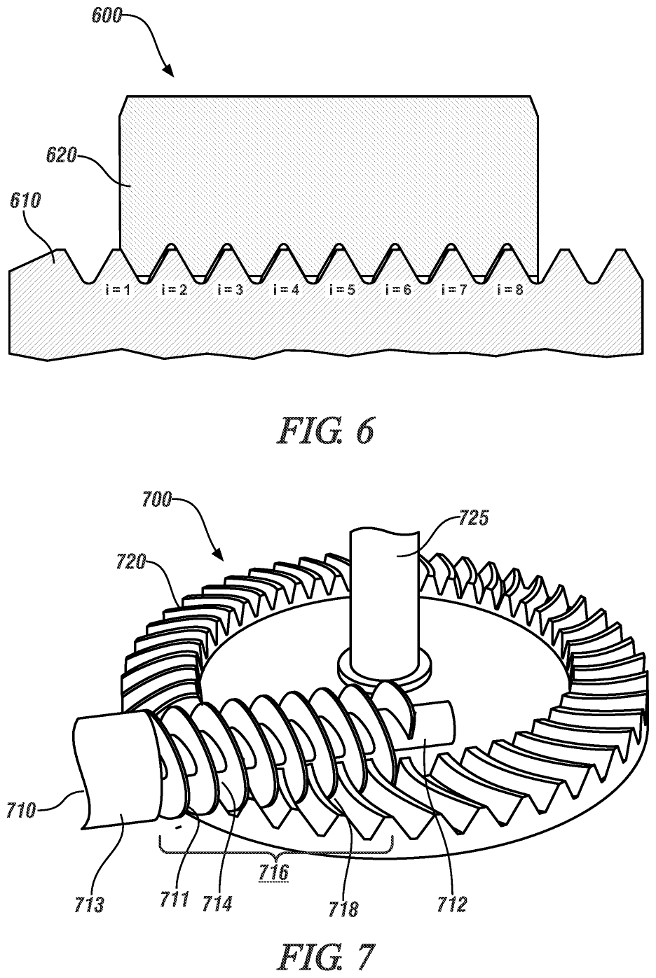

The fastener 100 is configured to meshingly engage a threaded bore element, such as a threaded nut, to form a fastener assembly that is capable of exerting a clamping force on an assembly. An example of a fastener assembly 600 including a threaded fastener 610 that is meshingly engaged with a nut 620 is shown with reference to FIGS. 5 and 6.

Referring again to FIG. 1, the shank portion 20 may be divided into a first portion 27 (A1), a second portion 28 (A2), a third portion 29 (B1) and a fourth portion (B2) 30, with a distal end of the first portion (A1) 27 defining the first end 24 of the shank portion 20, and with a proximal end of the fourth portion (B2) 30 adjoining the head 10 and defining the second end 26 of the shank portion 20.

In one embodiment, the fourth portion (B2) 30 is unthreaded, and does not engage with a counterpart threaded nut. Alternatively, the fourth portion (B2) 30 has symmetrical helical threads reaching to the second end 26. Alternatively, the fourth portion (B2) 30 has asymmetrical helical threads reaching to the second end 26 with the displacement of the pressure flank being constant and equal to a total axial displacement of the engaged threaded section in-use Sf, while the non-pressure flank may or may not be displaced.

In one embodiment, the third portion 29 (B1) is configured with asymmetrical helical threads, with the displacement of the pressure flank being constant and equal to a total axial displacement of the engaged threaded section in-use Sf, while the non-pressure flank may or may not be displaced. As employed herein, the term “symmetric” and related terms are in reference to a helical thread in the form of uniform helix having a constant pitch and a constant angle in relation to a longitudinal axis. As employed herein, the term “asymmetric” and related terms are in reference to helical thread in the form of non-uniform helix which may having a varying pitch and/or a varying angle in relation to the longitudinal axis.

In one embodiment, the first portion 27 (A1) is configured to meshingly engage a threaded nut, and may have symmetrical helical threads, or alternatively, may have asymmetrical helical threads, with the displacement of the pressure flank being constant and equal to a total axial displacement of the engaged threaded section in-use sf in one embodiment.

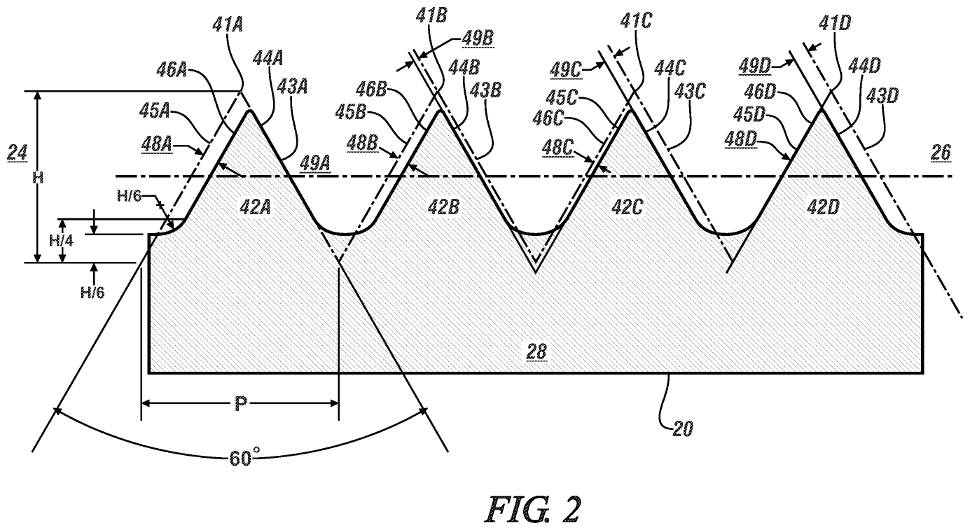

The second portion 28 (A2) is an asymmetric threaded portion with a progressive asymmetrical thread profile with asymmetrical helical threads that are defined by a progressively increasing axial displacement of the pressure flank of the helical thread portion. The second portion 28 has a first engaged helical thread portion 42A (shown with reference to FIG. 2) that is proximal to the first end 24 of the shank portion 20 and a final engaged helical thread portion 42D (shown with reference to FIG. 2) that is proximal to the second end 26 of the shank portion 20, as shown and described with reference to FIG. 2. The second portion 28 is that portion of the shank portion 20 that engages a threaded nut.

In one embodiment, the helical threads are formed on the external surface of the shank portion 20 by a cold metal forming process, e.g., cold-rolling, wherein the helical threads are formed onto the external surface of the cylindrical-shaped shank portion by squeezing the shank portion 20 between two thread dies on a thread rolling machine. Alternatively, the threaded portion 30 is formed on the external surface of the shank portion 20 by a metal cutting process. Alternatively, the threaded portion with asymmetrical helical threads is formed on an internal surface of a nut that meshingly engages a fastener.

FIG. 2 schematically illustrates an embodiment of the second portion 28 (A2) of the shank portion 20 of the fastener 100, which includes the asymmetric threaded portion with a progressive asymmetrical thread profile having a plurality of asymmetrical helical threads 42 that are defined by a progressively increasing axial displacement of the pressure flank. Four asymmetrical helical threads 42A, 42B, 42C and 42D are shown, and represent a non-limiting embodiment of the concepts herein. It is appreciated that there may be other quantities of asymmetrical helical threads. A first engaged helical thread portion 42A is proximal to the first end 24 of the shank portion and a final engaged helical thread portion 42D is proximal to the second end 26 of the shank portion 20 as shown. The illustrated second portion 28 has a 60° thread angle, but the concepts described herein are applicable to all thread angles. As configured, the cross-sectional areas and hence volumes of the asymmetrical helical threads 42A, 42B, 42C and 42D are constant. The axial displacement is in context of a longitudinal axis that is defined by the shank portion 20.

The second portion 28, i.e., the asymmetric threaded portion, of the shank portion 20 is illustrated in a resting, non-loaded, or unclamped position. The plurality of asymmetrical helical threads 42A, 42B, 42C, 42D of the second portion 28 has a progressively increasing axial displacement of a pressure flank 44 between the first engaged thread portion 42A and the final engaged thread portion 42D of the helical thread, and a progressively decreasing axial displacement of a non-pressure flank 46 of the helical threads 42 between the first end 24 and the second end 26 of the shank portion 20. As illustrated, there are four asymmetrical helical thread portions 42, designated as 42A, 42B, 42C, and 42D, with corresponding asymmetrical pressure flanks 44, designated as 44A, 44B, 44C, and 44D, and corresponding asymmetrical non-pressure flanks 46, designated as 46A, 46B, 46C, and 46D. The asymmetrical pressure flank 44 is the load-bearing side of the asymmetrical helical thread portion 42 and the asymmetrical non-pressure flank 46 is the non-load-bearing side of the asymmetrical helical thread portion 42. As appreciated, there may be any quantity of asymmetrical helical thread portions 42, with corresponding asymmetrical pressure flanks 44, and corresponding asymmetrical non-pressure flanks 46, in accordance with the design requirements and constraints of the particular application.

Also shown are broken lines indicating symmetrical helical threads 41, designated as 41A, 41B, 41C, and 41D, with corresponding symmetrical pressure flanks 43, designated as 43A, 43B, 43C, and 43D and symmetrical non-pressure flanks 45, designated as 45A, 45B, 45C, and 45D for purposes of illustrating the concept of the progressively increasing axial displacement of the asymmetrical pressure flanks 44 and the progressively decreasing axial displacement of the asymmetrical non-pressure flanks 46 of the asymmetrical helical threads 42.

Also indicated are pressure-side axial displacements 49, designated as 49A, 49B, 49C, and 49n. The pressure-side axial displacement 49A is zero, i.e., there is no pressure-side axial displacement on helical thread portion 41A.

Also indicated are non-pressure-side axial displacements 48, designated as 48A, 48B, 48C, and 48D. The non-pressure-side axial displacement 48D is zero, i.e., there is no non-pressure-side axial displacement on helical thread portion 42D.

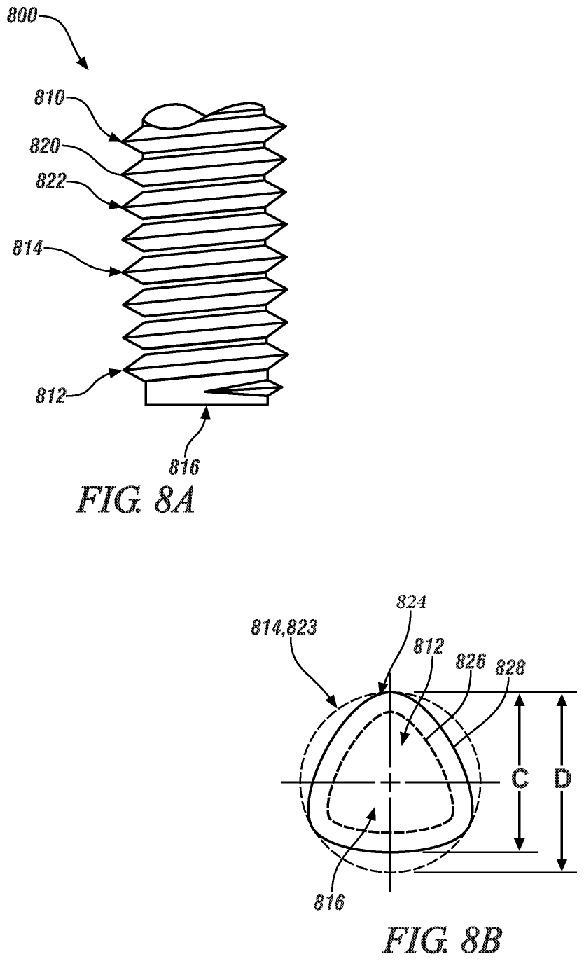

In one embodiment, and as described herein, the plurality of asymmetrical helical threads 42A, 42B, 42C, 42D are formed by a cold-rolling process helical thread that is cold-rolled onto the external surface of the cylindrically-shaped shank portion, which is initially unthreaded, or blank. Alternatively, the asymmetrical thread concept may also apply to thread forming fasteners having tapered tip portion and multi-lobular cross-sections where the cross-sections of both the blank and threaded portions of the shank portion are multilobular. This may include but not be limited to self-tapping fasteners. In an embodiment employing a multilobular thread and shank arrangement, the thread-forming threads are at a thread point end and form threads into a corresponding receiver, such as a nut member, an element having a smooth-bore hole, or an element fabricated from a compliant material such as wood or mild metal. These forming threads (e.g., as located at section A1 27 in FIG. 1) are followed by asymmetrical threads in the second portion (A2) 28, i.e., the asymmetric threaded portion, to meshingly engage with the formed nut threads. FIGS. 8A and 8B schematically show one embodiment of a multilobular fastener.

The second portion 28 has asymmetrical threads 42 with a progressively increasing axial displacement of a pressure flank 44 of the helical threads 42 between the first end 24 and the second end 26 of the shank portion 20, and a progressively decreasing axial displacement of a non-pressure flank 46 of the helical threads 42 between the first end 24 and the second end 26 of the shank portion 20. The plurality of asymmetrical helical threads 42 has a progressively increasing axial displacement of a pressure flank 44 of the helical threads 42 between the first end 24 and the second end 26 of the shank portion 20, and a progressively decreasing axial displacement of a non-pressure flank 46 of the helical threads 42 between the first end 24 and the second end 26 of the shank portion 20.

In one embodiment, the progressively increasing axial displacement of the pressure flank of the helical thread is determined for the plurality of successive helical thread portions employing a progressive relief relationship to achieve a uniform load distribution along the pressure flank of the helical thread portion between the first end and the second end of the shank portion. In one embodiment, the progressive relief relationship to achieve the uniform load distribution along the threads is a linear relationship wherein each successive rotational element, i.e., fractional turn or arc length of the helical ridge, is determined based upon a progression relationship that is defined as follows in EQ. 1.

sfi=f(i,n,sf) [1]
wherein
   i represents the i-th engaged helical thread;
   n represents total quantity of engaged threads;
   sfi represents the i-th pressure-side axial displacement from a nominal symmetrical thread; and
   sf represents a total axial displacement based upon an expected deflection of the helical thread between a first engaged helical thread portion and a final engaged helical thread portion in-use.

The relationship described with reference to EQ. 1 may be linear, or a non-linear progression. In one embodiment, the relationship defined by EQ. 1 may be an empirical relationship that is determined based upon experimental results.

The total pressure-side axial displacement sf is determined based upon an expected magnitude of deflection of the plurality of helical ridges of the asymmetrical portion of the helically-arranged threaded section when the asymmetrical portion of the helically-arranged threaded section is engaged in a clamped or loaded condition, i.e., in-use. The progressively increasing axial displacement of the pressure flank of the helical thread is determined for the plurality of successive helical elements employing a progressive relief relationship to achieve a uniform load distribution along the pressure flank of the helical thread between the first end and the second end of the shank portion. The non-pressure flank is determined to maintain a uniform or constant longitudinal cross-sectional area, and hence the volume of the helical thread between the first end and the second end of the shank portion is constant, i.e., there is no loss or reduction of material in the threads.

The asymmetrical threaded portion is composed of a plurality of successive helical elements arranged in series, and the progressively increasing axial displacement of the asymmetrical threaded portion between the first end and the second end of the shank portion is determined for the plurality of successive helical elements based upon an expected deflection of a respective one of the plurality of successive helical elements when in-use.

The progressively increasing axial displacement is determined for each of the plurality of successive helical elements to achieve a load that is evenly distributed on the plurality of successive helical elements of the helical thread in-use.

FIG. 3 schematically illustrates a process 300 for designing and arranging an embodiment of the second portion 28 with asymmetrical threads 42. The process 300 includes, initially, determining a plurality of parameters related to a proposed joint, such as preferred size(s) and quantity(ies) of fasteners, maximum values for expected loads, diameter of the fastener, nominal pitch, fastener material, etc., and a quantity of engaged threads and an associated expected axial load for a single fastener (S310).

The plurality of parameters are provided as inputs to an algorithm (S320) that, according to geometry, material and load of the assembly, calculates a first tentative Sf value. A progressive relief relationship can be defined according to the progressive relation described with reference to Eq. 1, or it can be defined according to another non-linear relationship. The individual relief values are designated as 0, Sf_1, Sf_2, Sf_3, et. seq., in ascending order from the first end 24 to the second end 26. In like manner, the relief values for the non-pressure flanks are designated as Sf, Sf_np_1, Sf_np_2, Sf_np_3, et. seq., in ascending order from the first end 24 to the second end 26 to achieve a uniform or constant volume of the individual threads. In this manner, an initial design for the fastener is created.

A 2-dimensional (2D) finite element analysis (FEA) model of a threaded assembly including the initial design for the fastener is generated, employing the helical thread between the first end and the second end of the shank portion that has the individual relief values for the pressure flanks that are designated as 0, Sf_1, Sf_2, Sf_3, et. seq., and the individual relief values for the non-pressure flanks that are designated as Sf, Sf_np_1, Sf_np_2, Sf_np3, et. seq. (S330). The 2D FEA model of the threaded assembly is subjected to axial loading to determine the load distribution along the pressure flank of the helical thread of the fastener between the first end and the second end of the shank portion (S340). When the load distribution along the pressure flank of the helical thread of the fastener due to axial loading as determined by the 2D FEA model demonstrates a uniform load distribution between the first end and the second end of the shank portion, the results are verified by generating a 3-dimensional (3D) FEA model of the threaded assembly (S350).

The 3D FEA model of the threaded assembly is subjected to axial loading to determine the load distribution along the pressure flank of the helical thread of the fastener between the first end and the second end of the shank portion (S360).

When the load distribution along the pressure flank of the helical thread of the fastener due to axial loading as determined by the 3D FEA model demonstrates a uniform load distribution between the first end and the second end of the shank portion of the fastener, the initial design for the fastener is captured and used as a production-intent design for the fastener (S70).

When the load distribution along the pressure flank of the helical thread of the fastener due to axial loading as determined by the 2D FEA model demonstrates a non-uniform load distribution between the first end and the second end of the shank portion, or when the load distribution along the pressure flank of the helical thread of the fastener due to axial loading as determined by the 3D FEA model demonstrates a non-uniform load distribution between the first end and the second end of the shank portion, the parameters of the progressive relief relationship and/or the Sf value, i.e., the axial displacement from a nominal symmetrical thread, are updated and the process described with reference to Steps S330, S340, S350, and S360 is repeated (S345).

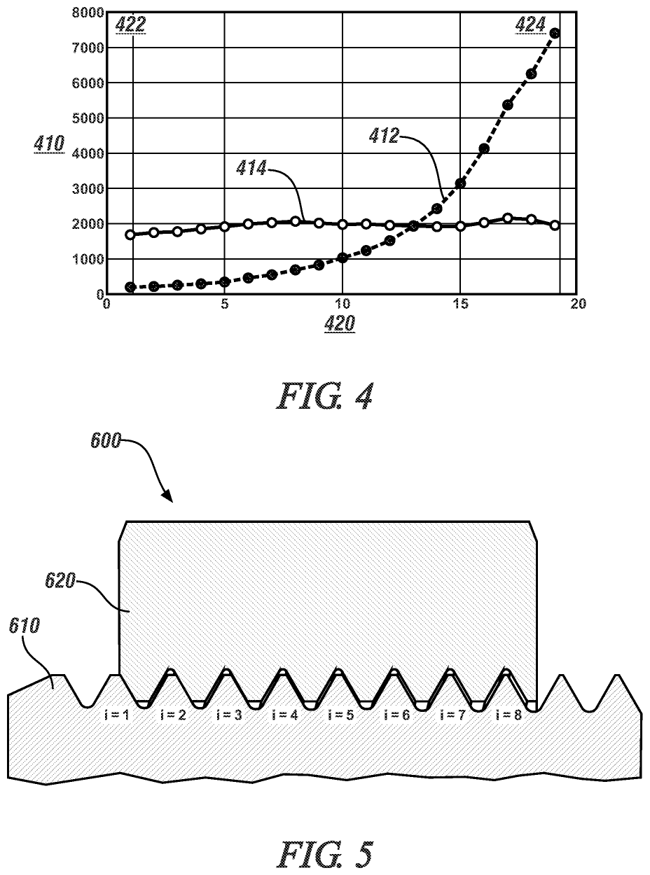

FIG. 4 graphically illustrates load distribution for fasteners, with load 410 indicated on the vertical axis and thread count 420 indicated on the horizontal axis. The thread count 420 is shown between a first end of the shank portion (towards a head of the fastener) 422 and a second end of the shank portion (towards a tip of the fastener) 424, and represents those threads that are engaged. A first line 412 is associated with fastener having a threaded portion with symmetrical helical threads, and indicates a non-uniform load distribution between the first end and the second end of the shank portion, with the load increasing towards the second end of the shank portion, i.e., towards the head of the fastener. A second line 414 is associated with fastener having a threaded portion with asymmetrical helical threads that have been designed employing the progressive relief relationship of Eq. 1, and refined in accordance with the process 300 that is described with reference to FIG. 3. The second line 414 indicates a uniform load distribution between the first end and the second end of the shank portion.

FIG. 5 schematically illustrates a fastener assembly 600 including a threaded fastener 610 that is meshingly engaged with a nut 620. The threaded fastener 610 is an embodiment of the fastener 100 described herein having a threaded portion with a plurality of asymmetrical helical threads (i=1, i=8) that have been designed employing the progressive relief relationship of Eq. 1, in an unclamped state. As illustrated, some of the asymmetrical helical threads (i=1, i=8) of the threaded fastener 610 are not in contact with a corresponding helical thread of the nut 620 in the unclamped state.

FIG. 6 schematically illustrates the fastener assembly 600 of FIG. 5, including threaded fastener 610 that is meshingly engaged with nut 620 in a clamped or loaded state. The plurality of asymmetrical helical threads (i=1, i=8) that have been designed employing the progressive relief relationship of Eq. 1. As illustrated, each of the asymmetrical helical threads (i=1, i=8) of the threaded fastener 610 has direct physical, load-bearing contact with a corresponding helical thread of the nut 620 in the loaded state. There is a uniform load distribution across the asymmetrical helical threads (i=1, i=8) between the first end and the second end.

FIG. 7 schematically illustrates a meshed gearset 700 having a worm gear 710, a ring gear 720 coupled to a shaft 725. The worm gear 710 is arranged as a rotatable shaft 713 with a continuous helical thread 714 arranged on a first end. The continuous helical thread 714 has an engagement portion 716 that has an asymmetrical threaded portion 718 that has been designed employing the progressive relief relationship. The engagement portion 716 meshingly engages and interacts with teeth of the ring gear 720 to rotate the shaft 725. The asymmetrical threaded portion 718 of the helical thread 714 has a progressively increasing axial displacement of a pressure flank between a first end 711 and a second end 712 of the helical thread 714. The progressively increasing axial displacement of the asymmetrical threaded portion between the first end and the second end comprises the progressively increasing axial displacement being determined for the plurality of successive helical elements based upon an expected deflection of a respective one of the plurality of successive helical elements when in-use. The asymmetrical threaded portion 718 includes a progressively decreasing axial displacement of a non-pressure flank of the helical thread between the first end 711 and the second end 712 of the helical thread 714. In one embodiment, the continuous helical thread 714 is formed by a cold-rolling process. In one embodiment, the continuous helical thread 714 is formed by a machine cutting operation.

FIGS. 8A and 8B schematically show a side-view (FIG. 8A) and corresponding end-view (FIG. 8B) of a shank 810 of an embodiment of a multilobular fastener 800 that has a continuous helical thread 820 with an asymmetrical threaded portion 822 that has been designed employing the progressive relief relationship described with reference to Eq. 1. The shank 810 includes a tapered portion 812 and a load-bearing untapered portion 814. In one embodiment, the load-bearing untapered portion 814 has a circular cross-section 823 with diameter C. In one embodiment, the tapered portion 812 has a multilobular cross-section 824 with a maximum diameter D. The multilobular cross-section 824 has a first, smaller diameter 826 at tip 816 and a second, larger diameter 828 (D) at its terminus where it joins the untapered portion 814. In one embodiment, and as shown, the multilobular cross-section 824 is trilobular. It is appreciated that embodiments of multilobular cross-section 824 may have 2 lobes, 4 lobes, or any suitable quantity of lobes in accordance with this description. The tapered portion 812 and the load-bearing untapered portion 814 are threaded with a continuous helical thread 820 as described herein with reference to FIGS. 1 through 7, with the untapered portion 814 having the asymmetrical threaded portion 820 arranged thereon. In one embodiment, the multilobular fastener 800 is a self-tapping device, with thread-forming threads at the tapered portion 812 starting at the tip 816. The thread-forming threads at the tapered portion 812 starting at the tip 816 are capable of forming threads in a corresponding receiver, such as a nut member, an element having a smooth-bore hole, or an element fabricated from a compliant material such as wood or mild metal. The thread forming threads are followed by the asymmetrical threaded portion 820 in the untapered portion 814 to meshingly engage with the formed nut threads.

The following clauses are provided:

Clause 1. A threaded fastener, comprising: an elongated shank portion having a first end and a second end opposed to the first end; and a helical thread arranged on an external surface of the shank portion; wherein the helical thread includes an asymmetrical threaded portion having a progressive asymmetrical thread profile; and wherein the progressive asymmetrical thread profile has a progressively increasing axial displacement of a pressure flank of the helical thread between the first end and the second end of the shank portion, and a progressively decreasing axial displacement of a non-pressure flank of the helical thread between the first end and the second end of the shank portion.

Clause 2. The threaded fastener of clause 1, further comprising a head portion arranged on the second end of the shank portion, wherein the head portion is engageable by a tool.

Clause 3. The threaded fastener of clauses 1 through 2, further comprising the progressively increasing axial displacement of the pressure flank of the helical thread being disposed between a first engaged helical thread that is proximal to the first end of the shank portion and a final engaged helical thread that is proximal to the second end of the shank portion, and a progressively decreasing axial displacement of a non-pressure flank of the helical thread between the first engaged helical thread and the final engaged helical thread of the shank portion.

Clause 4. The threaded fastener of clauses 1 through 3, comprising the progressively increasing axial displacement of the pressure flank of the helical thread being determined for a plurality of successive helical elements employing a progressive relief relationship to achieve a uniform load distribution along the pressure flank of the helical thread between the first engaged helical thread and the final engaged helical thread.

Clause 5. The threaded fastener of clauses 1 through 4, wherein a longitudinal cross-sectional area, and hence the volume of the helical thread is constant throughout the asymmetrical threaded portion.

Clause 6. The threaded fastener of clauses 1 through 5, wherein the progressively increasing axial displacement of the pressure flank of the helical thread is determined for the plurality of successive helical elements employing a progressive relief relationship to achieve a uniform load distribution along the pressure flank of the helical thread between the first end and the second end of the shank portion.

Clause 7. The threaded fastener of clauses 1 through 6, wherein the progressive relief relationship to achieve the uniform load distribution along the threads comprises each successive arc length of the helical thread being determined based upon a progression relationship, wherein the progression relationship is defined as: sfi=f(i,n,sf) wherein: i represents the i-th engaged helical thread number; n represents total quantity of engaged threads; and sfi represents the i-th axial displacement from a nominal symmetrical thread, and Sf represents the total relief/displacement value at the first engaged helical thread being determined based upon a magnitude of deflection of the helical ridge of the asymmetrical portion of the helically-arranged threaded section when the asymmetrical portion of the helically-arranged threaded section is engaged.

Clause 8. The threaded fastener of clauses 1 through 7, wherein the non-pressure flank is determined to maintain a uniform longitudinal cross-sectional area of the helical thread between the first end and the second end of the shank portion. Also, the minor diameter of the fastener can be adjusted to guarantee the constant longitudinal cross-section, i.e., thread volume is constant, such as occurs when a non-linear relationship is employed.

Clause 9. The threaded fastener of clauses 1 through 8, wherein the asymmetrical threaded portion is composed of a plurality of successive helical elements arranged in series, and wherein the progressively increasing axial displacement of the asymmetrical threaded portion between the first end and the second end of the shank portion comprises the progressively increasing axial displacement being determined for the plurality of successive helical elements based upon an expected deflection of a respective one of the plurality of successive helical elements when in-use.

Clause 10. The threaded fastener of clauses 1 through 9, wherein the progressively increasing axial displacement is determined for each of the plurality of successive helical elements to achieve a load that is evenly distributed on the plurality of successive helical elements of the helical thread in-use.

Clause 11. The threaded fastener of clauses 1 through 10, wherein the threaded fastener is formed from a blank fastener having a head portion and the shank portion, wherein the shank portion comprises a cylindrical-shaped shank portion, wherein the cylindrical-shaped shank portion has a constant diameter, and wherein the helical thread is cold-rolled onto the external surface of the cylindrical-shaped shank portion.

Clause 12. A fastener assembly, comprising a first element engageable to a second element via a threaded junction; the first element having a first helical thread; the second element having a second helical thread that meshingly engages the first helical thread of the first element; wherein the first helical thread has an asymmetrical threaded portion including a progressively increasing axial displacement of a pressure flank of the first helical thread between a first end and a second end for the first element; and wherein the asymmetrical threaded portion includes a progressively decreasing axial displacement of a non-pressure flank of the first helical thread between the first end and the second end of the first element.

Clause 13. The fastener assembly of clause 12, wherein a longitudinal cross-sectional area, and hence volume of the first helical thread is constant throughout the asymmetrical threaded portion.

Clause 14. The fastener assembly of clauses 12 through 13, wherein the first element comprises an elongated cylindrical shaft.

Clause 15. The fastener assembly of clauses 12 through 14, wherein the first element comprises a threaded nut.

Clause 16. The fastener assembly of clauses 12 through 15, wherein the asymmetrical threaded portion of the first helical thread is a continuous device that is composed of a plurality of successive helical elements arranged in series, and wherein the progressively increasing axial displacement of the asymmetrical threaded portion between the first end and the second end of the first element comprises the progressively increasing axial displacement being determined for the plurality of successive helical elements based upon an expected deflection of a respective one of the plurality of successive helical elements in-use.

Clause 17. The fastener assembly of clauses 12 through 16, wherein the progressively increasing axial displacement is determined for each of the plurality of successive helical elements to achieve a load that is evenly distributed over the plurality of successive helical elements of the helical thread in-use.

Clause 18. The threaded fastener of clauses 12 through 17, wherein the asymmetrical threaded portion is composed of a plurality of successive helical elements arranged in series, and wherein the progressively increasing axial displacement of the asymmetrical threaded portion between the first end and the second end of the first element comprises the progressively increasing axial displacement being determined for the plurality of successive helical elements employing a progressive relief relationship to ensure a uniform load being distributed along the pressure flank of the helical thread between the first end and the second end of the first element.

Clause 19. The threaded fastener of clauses 12 through 18, wherein the progressive relief relationship to achieve the uniform load distribution along the threads comprises each successive arc length of the helical thread being determined based upon a linear progression rule, wherein the linear progression rule is defined as: sfi=f(i,n,sf), wherein: i represents an i-th engaged helical thread; n represents total quantity of the engaged threads; sfi represents an axial displacement of the i-th engaged helical thread from a nominal symmetrical thread; and sf represents a total axial displacement based upon an expected deflection in-use.

Clause 20. A process for fabricating a threaded fastener, the process comprising: determining an arrangement for a continuous helical ridge, the arrangement for the continuous helical ridge including a plurality of helical elements having a progressively increasing axial displacement between a first end and a second end, wherein the progressive relief relationship achieves a uniform load distribution along a pressure flank of the continuous helical ridge between the first end and the second end; and forming via a cold-rolling process, the arrangement for the continuous helical ridge on an outer surface of a blank shank.

Clause 21. A meshed gearset, comprising: a first element meshingly engaged to a second element; the first element having an engagement portion; the second element having a helical thread that meshingly engages the engagement portion of the first element; wherein the helical thread has an asymmetrical threaded portion including a progressively increasing axial displacement of a pressure flank of the helical thread between a first end and a second end of the second element; wherein the progressively increasing axial displacement of the asymmetrical threaded portion between the first end and the second end comprises the progressively increasing axial displacement being determined for the plurality of successive helical elements based upon an expected deflection of a respective one of the plurality of successive helical elements when in-use; and wherein the asymmetrical threaded portion includes a progressively decreasing axial displacement of a non-pressure flank of the helical thread between the first end and the second end of the second element.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A threaded fastener, comprising:
an elongated shank portion having a first end and a second end opposed to the first end; and
a helical thread arranged on an external surface of the shank portion;
wherein the helical thread includes an asymmetrical threaded portion having a progressive asymmetrical thread profile; and
wherein the progressive asymmetrical thread profile has a progressively increasing axial displacement of a pressure flank of the helical thread between the first end and the second end of the shank portion, and a progressively decreasing axial displacement of a non-pressure flank of the helical thread between the first end and the second end of the shank portion.

2. The threaded fastener of claim 1, further comprising a head portion arranged on the second end of the shank portion, wherein the head portion is engageable by a tool.

3. The threaded fastener of claim 1, wherein the progressively increasing axial displacement of the pressure flank of the helical thread is determined for a plurality of successive helical elements employing a progressive relief relationship to achieve a uniform load distribution along the pressure flank of the helical thread between the first end and the second end of the shank portion.

4. The threaded fastener of claim 1, further comprising the asymmetric threaded portion being disposed between a first engaged helical thread portion that is proximal to the first end of the shank portion and a final engaged helical thread portion that is proximal to the second end of the shank portion, and a progressively decreasing axial displacement of a non-pressure flank of the helical thread between the first engaged helical thread portion and the final engaged helical thread portion of the shank portion.

5. The threaded fastener of claim 4, wherein the progressively increasing axial displacement of the pressure flank of the helical thread is determined for a plurality of successive helical elements employing a progressive relief relationship to achieve a uniform load distribution along the pressure flank of the helical thread between the first engaged helical thread portion and the final engaged helical thread portion.

6. The threaded fastener of claim 5, wherein the progressive relief relationship to achieve the uniform load distribution along the pressure flank of the helical thread comprises each successive arc length of the helical thread being determined based upon a progression relationship, wherein the progression relationship is defined as:
sfi=f(i,n,sf)
wherein:
i represents an i-th engaged helical thread portion;
n represents total quantity of the engaged threads;
sfi represents an axial displacement of the i-th engaged helical thread portion from a nominal symmetrical thread; and
sf represents a total axial displacement based upon an expected deflection of the helical thread between a first engaged helical thread portion and a final engaged helical thread portion in-use.

7. The threaded fastener of claim 6, wherein the non-pressure flank is determined to maintain a uniform longitudinal cross-sectional area of the helical thread portion between the first end and the second end of the shank portion.

8. The threaded fastener of claim 1, wherein a longitudinal cross-sectional area of the helical thread is constant throughout the asymmetrical threaded portion.

9. The threaded fastener of claim 1, wherein the asymmetrical threaded portion is composed of a plurality of successive helical elements arranged in series, and wherein the progressively increasing axial displacement of the pressure flank of the asymmetrical threaded portion between the first end and the second end of the shank portion comprises the progressively increasing axial displacement being determined for the plurality of successive helical elements based upon an expected deflection of a respective one of the plurality of successive helical elements when in-use.

10. The threaded fastener of claim 9, wherein the progressively increasing axial displacement is determined for each of the plurality of successive helical elements to achieve a load that is evenly distributed on the plurality of successive helical elements of the helical thread portion in-use.

11. The threaded fastener of claim 1, wherein the threaded fastener is formed from a blank having a head portion and the shank portion, wherein the shank portion comprises a cylindrical-shaped shank portion, wherein the cylindrical-shaped shank portion has a constant diameter, and wherein the helical thread is cold-rolled onto the external surface of the cylindrical-shaped shank portion.

12. A fastener assembly, comprising:
a first element engageable to a second element via a threaded junction;
the first element having a first helical thread; and
the second element having a second helical thread that engages the first helical thread of the first element;
wherein the first helical thread has an asymmetrical threaded portion including a progressively increasing axial displacement of a pressure flank of the first helical thread between a first end and a second end of the first element; and
wherein the asymmetrical threaded portion includes a progressive asymmetrical thread profile having a progressively decreasing axial displacement of a non-pressure flank of the first helical thread between the first end and the second end of the first element.

13. The fastener assembly of claim 12, wherein a longitudinal cross-sectional area of the first helical thread is constant throughout the asymmetrical threaded portion.

14. The fastener assembly of claim 12, wherein the first element comprises an elongated cylindrical shaft.

15. The fastener assembly of claim 12, wherein the first element comprises a threaded nut.

16. The fastener assembly of claim 12, wherein the asymmetrical threaded portion of the first helical thread is a continuous device that is composed of a plurality of successive helical elements arranged in series, and wherein the progressive asymmetrical thread profile having the progressively increasing axial displacement of the asymmetrical threaded portion between the first end and the second end of the first element comprises the progressively increasing axial displacement being determined for a plurality of successive helical elements based upon an expected deflection of a respective one of the plurality of successive helical elements in-use.

17. The fastener assembly of claim 16, wherein the progressively increasing axial displacement is determined for each of the plurality of successive helical elements to achieve a load that is evenly distributed over the plurality of successive helical elements in-use.

18. The fastener assembly of claim 12, wherein the asymmetrical threaded portion is composed of a plurality of successive helical elements arranged in series, and wherein the progressively increasing axial displacement of the asymmetrical threaded portion between the first end and the second end of the first element comprises the progressively increasing axial displacement being determined for the plurality of successive helical elements employing a progressive relief relationship between a first engaged helical thread portion that is proximal to the first end and a final engaged helical thread portion that is proximal to the second end to achieve a uniform load distribution along the pressure flank of the helical thread portion between the first end and the second end of the first element.

19. The fastener assembly of claim 18, wherein the progressive relief relationship to achieve the uniform load distribution along the threads comprises each successive arc length of the helical thread portion being determined based upon a linear progression relationship, wherein the linear progression relationship is defined as:
sfi=f(i,n,sf)
wherein:
i represents an i-th engaged helical thread portion;
n represents total quantity of the engaged threads;
sfi represents an axial displacement of the i-th engaged helical thread portion from a nominal symmetrical thread; and
sf represents a total axial displacement based upon an expected deflection in-use.

20. A process for fabricating a threaded fastener, the process comprising:
determining an arrangement for a continuous helical ridge, the arrangement for the continuous helical ridge including a plurality of helical elements having a progressively increasing axial displacement between a first end and a second end that is defined by a progressive relief relationship, wherein the progressive relief relationship achieves a uniform load distribution along a pressure flank of the continuous helical ridge between the first end and the second end; and
forming via a cold-rolling process, the arrangement for the continuous helical ridge on an outer surface of a blank shank.
